(19) United States
(12) Patent Application Publication
(10) Pub. No.: US 2026/0332018 A1
(43) Pub. Date: Oct. 22, 2026

(54) MAGNETIC GEAR SYSTEMS AND METHODS

(71) Applicants: The Texas A&M University System, College Station, TX (US); Kaney Aerospace, Inc., Rockford, IL (US)

(72) Inventors: Hamid A. Toliyat, College Station, TX (US); Bryton Praslicka, College Station, TX (US); Logan Smith, College Station, TX (US); Daniel Zamarron, Bryan, TX (US); Adam White, Beavercreek, OH (US); Nicholas Palmer, Gainesville, GA (US); Don Knight, Davis, IL (US); Tazio Stefanelli, Rockton, IL (US)

(73) Assignees: The Texas A&M University System, College Station, TX (US); Kaney Aerospace, Inc., Rockford, IL (US)

(21) Appl. No.: 19/106,625

(22) PCT Filed: Aug. 25, 2023
(86) PCT No.: PCT/US2023/031176

§ 371 Date: Feb. 25, 2025

Related U.S. Application Data
(60) Provisional application No. 63/400,885, filed on Aug. 25, 2022.

(51) Int. Cl. H02K 49/10; F16H 1/32; H02K 1/278; H02K 1/2791

(52) U.S. Cl. CPC H02K 49/102; F16H 1/32; H02K 1/278; H02K 1/2791; F16H 2001/323

(57) ABSTRACT

Improvements to aspects of magnet gear systems are disclosed. In various aspects, a support system for rotors includes bearing supports to maintain an air gap between adjacent rotors. In various aspects, a modular system for creating magnetic poles using a single magnet. In various aspects, an eccentric rotor design uses a flux shield to reduce losses to improve performance of the magnetic gear system. In various aspects, a multi-stage magnetic gear systems include combinations of axial and/or radial flux rotor designs. In various aspects, a back iron design includes contoured features designed to retain magnets in a press-fit arrangement.

### CROSS-REFERENCE TO RELATED APPLICATIONS

This patent application claims priority from, and incorporates by reference the entire disclosure of U.S. Provisional Application No. 63/400,885, filed on Aug. 25, 2022.

### STATEMENT REGARDING FEDERALLY SPONSORED RESEARCH

This invention was made with government support under FA8649-21-P-1627 awarded to Kaney Aerospace (STTR Prime to USAF AFRL/SBRK). The government has certain rights in the invention.

### TECHNICAL FIELD

The present disclosure relates generally to gear systems and more particularly, but not by way of limitation, to magnetic gear systems and methods.

### BACKGROUND

This section provides background information to facilitate a better understanding of the various aspects of the disclosure. It should be understood that the statements in this section of this document are to be read in this light, and not as admissions of prior art.

Magnetic gears perform the same task as their mechanical counterparts; however, they do so through the modulated interaction between the flux generated by magnets instead of through mechanical interaction between gear teeth. While magnetic gears provide various benefits over mechanical gears, a variety of aspects of their operation can be improved.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In some aspects, an air gap support system for a magnetic gear system includes a plurality of supports secured to a magnetically active or inactive body supporting a magnet array of the magnetic gear system. The plurality of supports are in rolling contact with a rotating portion of the magnetic gear system to resist axial movement of the rotating portion due to magnetic forces.

In some aspects, an air gap support system for a magnetic gear system includes a plurality of supports secured to a magnetically active or inactive body supporting a magnet array of the magnetic gear system. The plurality of supports are in rolling contact with a stationary portion of the magnetic gear system to resist axial movement of the rotating portion due to magnetic forces.

In some aspects, a modular system for forming a low-pole count rotor and a high-pole count rotor includes a plurality of magnet segments, each magnet segment having the same dimensions. The low-pole count rotor comprises poles made up of multiple magnet segments placed adjacent to one another. The high-pole count rotor comprises poles made up of fewer magnet segments than the poles of the low-pole count rotor.

In some aspects, each pole of the low-pole rotor comprises two or more magnet segments.

In some aspects, each magnet segment is an arc-shaped magnet segment.

In some aspects, each magnet segment is a rectangular magnet.

In some aspects, a modular system for forming a low-pole count rotor and a high-pole count rotor in an axial flux arrangement system includes an air gap between the low-pole count rotor and a modulator rotor is 1.5× to 3× a thickness of an air gap between the high-pole count rotor and the modulator rotor so as to minimize axial forces on the modulator rotor.

In some aspects, a modular system for a multistage radial flux magnetic gear-axial flux magnetic gear system includes a modulator rotor of a radial flux stage configured as a low-speed rotor, and a high-speed rotor of an axial flux magnetic gear stage that is retained by a flanged structural feature that retains the modulator rotor of the radial flux stage so as to minimize axial forces on the modulator rotor.

In some aspects, a cycloidal magnetic gear drive includes an inner rotor; an outer rotor; and a flux redirecting body configured to eccentrically rotate within an annulus formed between the inner and outer rotor. The flux redirecting body has a magnetic permanence and reluctance that creates a low reluctance flux path between the inner and outer rotors to create a torque on the inner rotor in the same direction as the torque generated in the small air gap on the radially opposite side of the cycloidal drive.

In some aspects, a multi-stage cycloidal magnetic gear system includes at least two cycloidal magnetic gears nested in-plane.

In some aspects, the multi-stage cycloidal magnetic gear system further includes a first pin disk coupled to an inner rotor of a first stage of the multi-stage cycloidal magnetic gear system and comprising a cam, wherein the cam is configured to create eccentric motion of a second stage of the multi-stage cycloidal magnetic gear system.

In some aspects, the first stage of the multi-stage cycloidal magnetic gear system includes an outer rotor that is shared with an inner rotor of a second stage of the multi-stage cycloidal magnetic gear system.

In some aspects, a cycloidal magnetic gear system includes an inner rotor and an outer rotor disposed around the inner rotor, wherein the inner rotor is driven by a cam rotor of a low-speed rotor of an axial flux magnetic gear such that the inner rotor has an eccentric rotation, the cam rotor having a counterweight.

In some aspects, a magnet retention system includes a back iron comprising a plurality of contoured features; and a plurality of magnets, each of the magnets having an oval-shaped cross-section and being configured to be press fit into a contoured feature of the plurality of contoured features such that the plurality of magnets are retained by the plurality of contoured features.

In some aspects, a magnetic gear system includes a nested radial flux coaxial magnetically geared machine connected to an axial flux coaxial magnetic gear system, wherein a low-speed rotor of the nested radial flux coaxial magnetic gear system is mechanically connected to a high-speed rotor of the axial flux coaxial magnetic gear system and is a single rigid body.

In some aspects, a magnetic gear system includes a nested radial flux coaxial magnetically geared system connected to an axial flux coaxial magnetic gear system, wherein a housing of the magnetic gear system may be shared with grounded components of the axial flux coaxial magnetic gear.

In some aspects, a magnetic gear system includes a radial flux cycloidal magnetic gear connected to an axial flux coaxial magnetic gear. A low-speed rotor of the axial flux coaxial magnetic gear is mechanically coupled to the radial flux cycloidal magnetic gear, and the low-speed rotor of the axial flux coaxial magnetic gear includes a cam that causes eccentric motion of a following stage of the magnetic gear system.

In some aspects, a multi-stage magnetic gear system includes a first stage axial flux coaxial magnetic gear that is integrated in series with a second stage radial flux cycloidal type magnetic gear. A low-speed rotor of the axial flux coaxial magnetic gear is mechanically connected to a radial flux cycloidal magnetic gear, the low-speed rotor is a single rigid body, and the second stage radial flux cycloidal magnetic gear is eccentrically connected to the low-speed rotor of the axial flux coaxial magnetic gear to cause eccentric motion of a following stage of the magnetic gear system.

In some aspects, a multi-stage magnetic gear system includes a radial flux cycloidal magnetic gear that is configured to be a higher-speed first stage; and an axial flux coaxial magnetic gear that is configured to be a lower-speed second stage. The radial flux cycloidal magnetic gear is connected to a high-speed rotor of the axial flux coaxial magnetic gear as a single rigid body, and the radial flux cycloidal magnetic gear is configured as an outer rotor without eccentric motion and the outer rotor of the radial flux cycloidal magnetic gear is mechanically connected to the high-speed rotor of the axial flux coaxial magnetic gear.

In some aspects, a multi-stage magnetic gear system includes a radial flux cycloidal magnetic gear that is configured as a higher-speed first stage; and an axial flux coaxial magnetic gear that is configured as a lower-speed second stage. The radial flux cycloidal magnetic gear is mechanically coupled to a high-speed rotor of the axial flux coaxial magnetic gear, and when a low-speed rotation of the radial flux cycloidal magnetic gear is the rotation of the inner or outer rotor about its own axis while moving eccentrically, the high-speed rotor of the axial flux coaxial magnetic gear has pins extending toward the first stage that couple to holes of larger diameter on the output disk of the radial flux cycloidal magnetic gear.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIGS. 1-3 illustrate air gap supports for a magnetic gear system, according to aspects of the disclosure;

FIGS. 4A-4D illustrate a modular system for making multiple-pole rotors, according to aspects of the disclosure;

FIGS. 5-6 illustrate a modular system for making multiple-pole rotors, according to aspects of the disclosure;

FIG. 7 illustrates force distribution on an inner rotor of a cycloidal magnetic gear, according to aspects of the disclosure;

FIG. 8 illustrates a schematic diagram of a cycloidal magnetic gear with a flux redirecting body, according to aspects of the disclosure;

FIGS. 9-12 illustrate aspects of radial flux cycloidal magnetic gearboxes, according to aspects of the disclosure;

FIG. 13 illustrates aspects of a magnet rotor in a radial flux machine or magnetic gear system;

FIG. 14 illustrates aspects of a multistage coaxial magnetic gearbox;

FIG. 15 illustrates aspects of an axial flux magnetic gear with air gap supports; and

FIGS. 16-20 illustrate aspects of multistage magnetic gears consisting of axial flux coaxial magnetic gear and radial flux cycloidal magnetic gear.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

### Air Gap Supports

Magnetic gears perform the same task as their mechanical counterparts. However, they do so through the modulated interaction between the flux generated by magnets instead of through mechanical interaction between teeth. An axial flux magnetic gear transfers the torque by creating magnetic flux in the direction of the axis of rotation. This means that the two rotors that contain magnets are attracted to each other and want to close the air gap between them. This causes extremely large forces that must be counteracted in order for the magnetic gear to function properly.

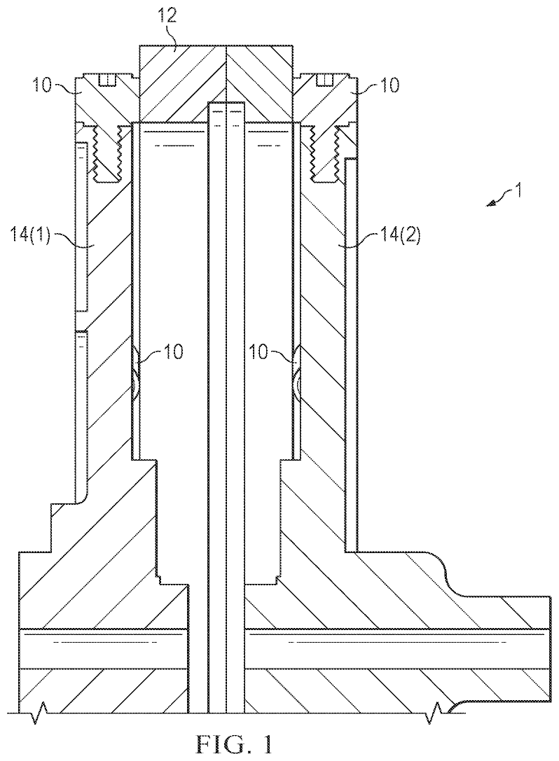

FIGS. 1-3 illustrate air gap supports for a magnetic gear system 1, according to aspects of the disclosure. FIG. 1 is a partial sectional view of magnetic gear system 1. Magnetic gear system 1 includes a modulator ring 12 and housings 14(1) and 14(2) that are disposed on either side of modulator ring 12. Each housing 14 is configured to support a plurality of magnetic poles. As noted above, the plurality of magnetic poles are attracted to each other, and the resulting in forces tend to effect the air gap between housings 14(1) and 14(2). To maintain a stable air gap between housings 14(1) and 14(2), each housing 14 includes a plurality of supports 10 that are configured to contact and roll upon modulator ring 12, limiting an amount of axial displacement of housings 14(1) and 14(2). This significantly reduces the influence of the leakage magnetic flux, greatly reducing the risk of bearing currents, losses, and thereby lengthening the life of the bearings. An added benefit of this topology is that by locating the supports 10 on housings 14, the thickness of modulator ring 12 can be determined independent of support design constraints. This allows the supports on either side of the modulator ring 12 to be designed more independently. This approach locates the supports 10 so that they are not in the influence of the magnetic flux, which removes the problem of magnetic cycling occurring on the supports, allowing for standard materials to be used. Supports 10 can be used in any axial flux magnetic gear and can be used for any application requiring a gear ratio.

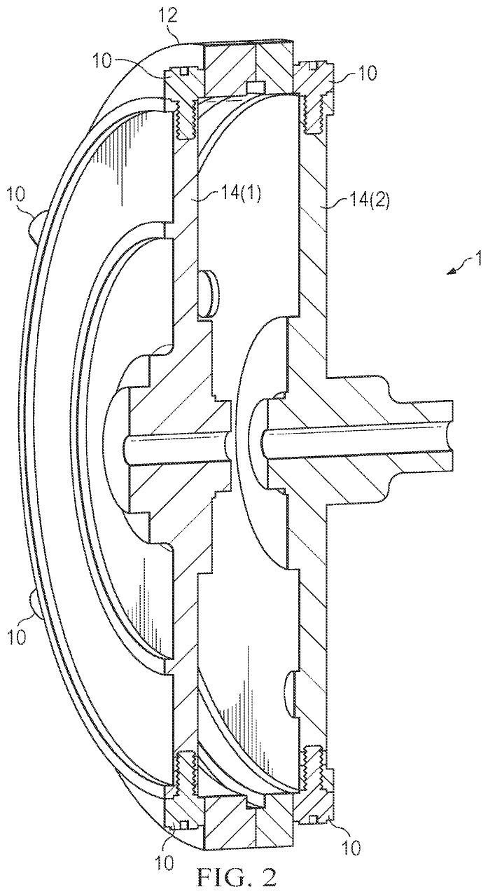

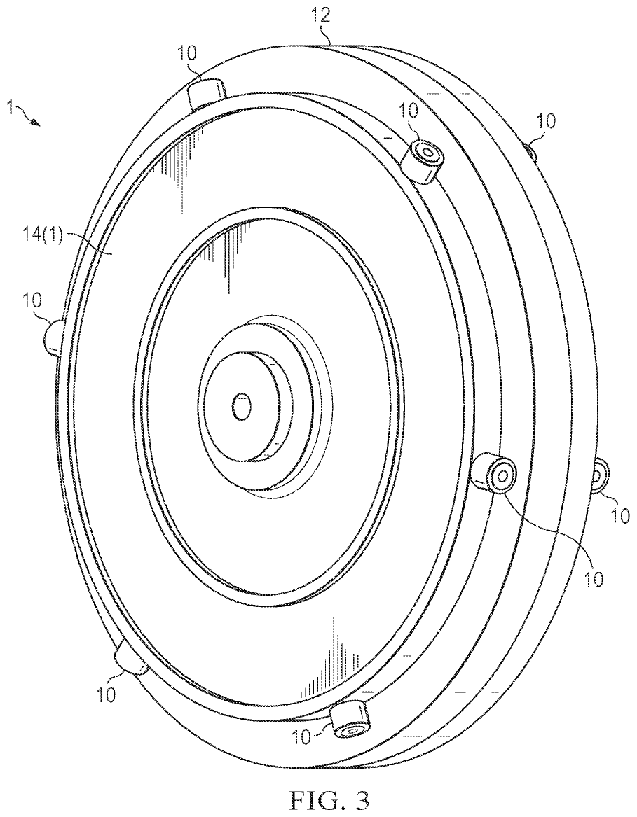

Each support 10 is rotatably secured to its housing and includes a head 10(1) and a shaft 10(2). Head 10(1) accts as a roller that rotates about shaft 10(2) and upon a surface of modulator ring 12. In some aspects, support 10 includes a bearing between head 10(1) and shaft 10(2) such that head 10(1) may rotate relative to shaft 10(2) (see FIG. 3). In some aspects, head 10(1) and shaft 10(2) rotate together and relative to housing 14. In these aspects, a bearing may positioned between shaft 10(2) and housing 14 (see FIG. 2).

In some aspects, parameters of magnetic gear system 1 may be adjusted to minimize axial flux to reduce the number of supports 10 required (i.e., the smaller the axial forces, the fewer supports that are needed to balance the axial forces). For example, parameters that may be adjusted include: air gaps, magnet thicknesses, inner and outer radii, and the relative radii of each rotor within the axial flux magnetic gear. Adjusting these parameters to reduce/minimize axial flux allows for thinner modulators, smaller air gaps, and less supports, ultimately increasing the overall torque output of the magnetic gear per unit mass. This can be achieved by using conventional surface permanent magnets on both rotors, or by Halbach topologies on either or both rotors.

### Modular Rotor Design for Magnetic Gears

Magnetic gears, like mechanical gears, convert high-speed, low-torque rotation to low-speed, high-torque rotation. The coaxial magnetic gear has two primary magnetic topological arrangements: the radial flux magnetic gear and the axial flux magnetic gear. To enable the action of gearing, one permanent magnet rotor will have a particular number of pole pairs, and the other permanent magnet rotor must have a different amount of pole pairs. One challenge hindering magnetic gear commercialization to economies of scale is the complexity, number of unique parts, and consequential high manufacturing cost associated with magnetic gears. To mitigate these problems, disclosed herein is a novel magnet arrangement for radial flux and axial flux magnetic gears that reduces the number of unique magnets in the system, while minimizing impact on performance, in order to create low cost, highly manufacturable, high performance magnetic gears.

Typically, magnetic gears require unique magnets to make up the high-pole count rotor and the low-pole count rotor. Typically, four unique magnet drawings and part numbers are associated with a simple surface permanent magnet gear. With both rotors using a Halbach array, this can result in 8 unique magnet designs each requiring their own manufacturing. The method disclosed herein reduces the total number of unique magnet parts in a single stage magnetic gear to 1 or 2 depending on whether commercial off the shelf rectangular magnets are used (1 unique magnet total) or whether arc magnet are used (2 unique parts for SPM, 4 unique parts for Halbach array SPM).

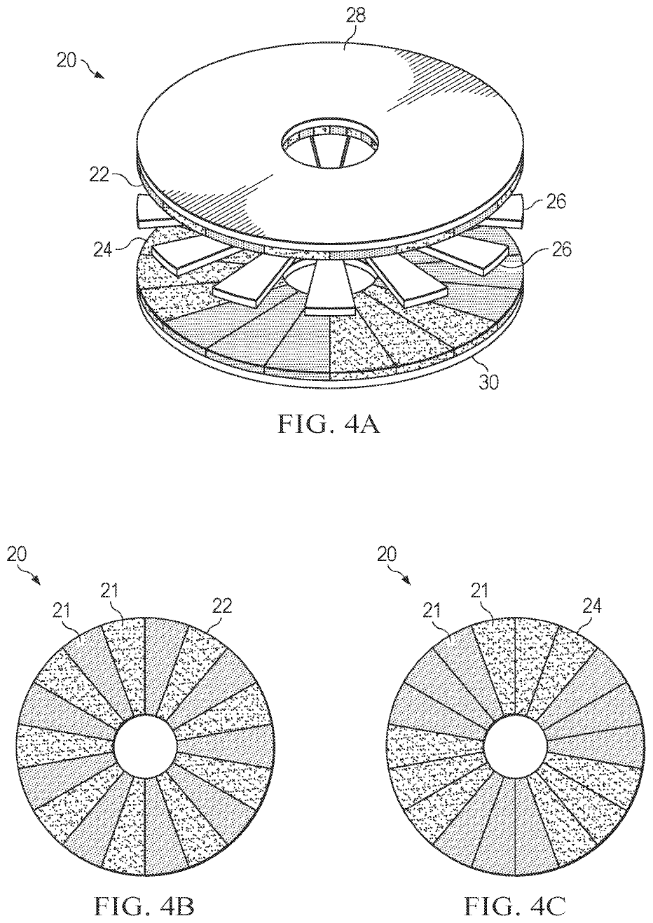

An axial flux magnetic gear typically includes a high-pole count rotor and a low-pole count rotor. The disclosed design involves using multiple magnet pieces per pole on the low pole count rotor. For example, instead of using one large arc magnet magnetized axially, three magnet segments are placed adjacent to each other with the same magnetization orientation to create a single pole on the low-pole count rotor. On the high-pole count rotor, the pole pairs and geometry shall be designed such that fewer of the same sized magnet pieces can be used to form the low-pole count rotor. Thus, a shared part is used for both the high pole count rotor and the low pole count rotor, as opposed to creating two unique parts. This shared-part design simplifies the manufacturing process to make it less expensive and quicker to make the high-and low-pole count rotors. This method may be practiced with the surface per-magnet arrangement, as well as the consequent pole arrangement. The method may also be practiced with conventional or Halbach array. An example of this arrangement is given in FIGS. 4A-4C.

FIG. 4A is an exploded assembly of a magnetic gear system 20 that includes a pair of rotors 22, 24, a plurality of modulators 26 positioned between rotors 22, 24, and a pair of housings 28, 30 upon which rotors 22, 24 are affixed, respectively. FIG. 4B illustrates rotor 22 having a high-pole count (i.e., 18 poles), with each pole comprising a single magnet 21. FIG. 4C. illustrates rotor 24 having a low-pole count (i.e., 6 poles), with each pole comprising three magnets 21. To create the pole arrangements illustrated in FIGS. 4A-4C, it is simply a matter of arranging magnets 21 with the desired pole direction. Magnet 21 has a first pole orientation when facing a first direction, and a second, opposite pole orientation when facing a second direction. Via this design, it will be appreciated by those having skill in the art that the dimensions of magnet 21 can be configured to suit various high/low pole count rotor pairs.

FIG. 5 illustrates another aspect in which square, commercial-off-the-shelf magnets are used to create a discretized arc magnet with non-cylindrical geometry. FIG. 5 illustrates a plurality of magnets 30 positioned in a discretized arc arrangement for a radial flux magnetic gear. The example in FIG. 5 illustrates a single rotor 32 comprising a plurality of poles 34, each pole 34 comprising five magnets 30. Magnets 30 of each adjacent pole 34 are arranged so that adjacent poles 34 alternate direction. This technique may be used to create a low-cost magnet gear with commercial off the shelf rectangular magnets as opposed to needing to create a unique arc magnet, and is best practiced when a low volume of the magnetic gear product may be developed or for prototyping.

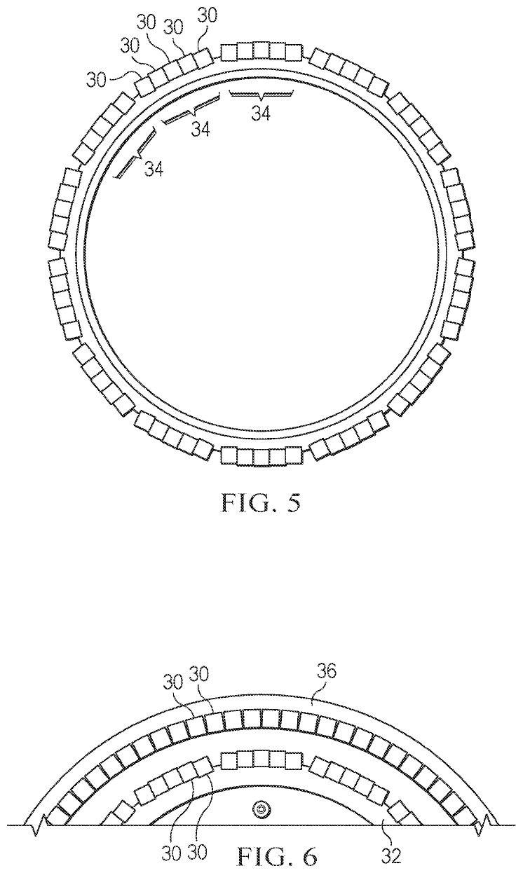

Aspects of the design of FIG. 5 may be combined with the aspects of the design of FIGS. 4A-4D in order to allow the two magnet rotors again to use the same magnet to create the low pole count and the high pole count magnet rotor, again reducing the total count of unique parts, which can reduce complexity and cost of manufacturing. An example of using the discussed arrangement for a radial flux magnetic gear is shown in FIG. 6. FIG. 6 illustrates rotor 32 positioned coaxially within a rotor 36 that comprises a plurality of magnets 30, with alternating magnets 30 arranged with alternating poles.

### Flux Redirecting Body for Cycloidal Magnetic Gear Drives

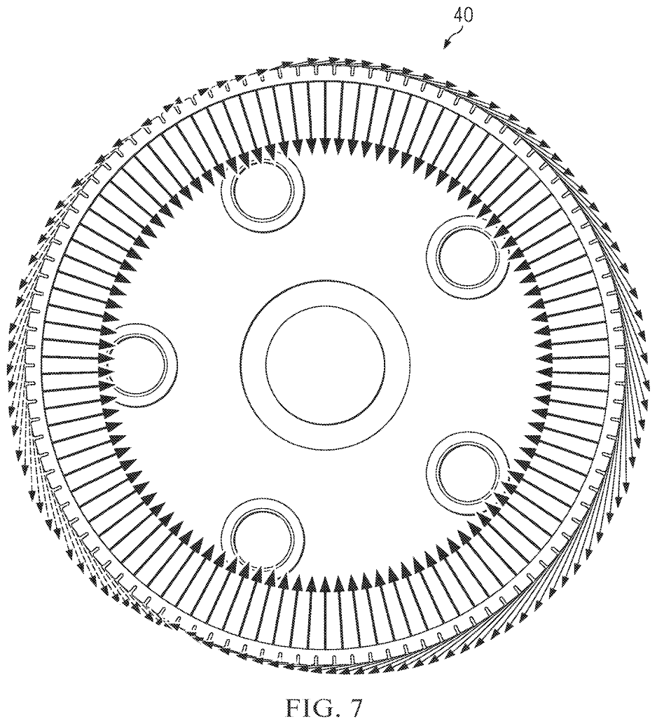

A cycloidal magnetic gear has a similar motion to the mechanical cycloidal type drive, yet uses modulated electromagnetic fields instead of teeth to transfer torque. FIG. 7 illustrates a force distribution on an inner rotor 40 of a cycloidal magnetic gear at a particular instant of time. The arrows shown in FIG. 7 illustrate a direction and magnitude of the forces acting upon rotor 40. Magnetic interaction of the inner rotor with an outer rotor will give rise to torques acting on the inner rotor. On one side of the inner rotor, the torques have a positive value and act in the same direction of rotation of the inner rotor. However, on an opposite side of the inner rotor, the torques have a negative value and act opposite the direction of rotation of the inner rotor.

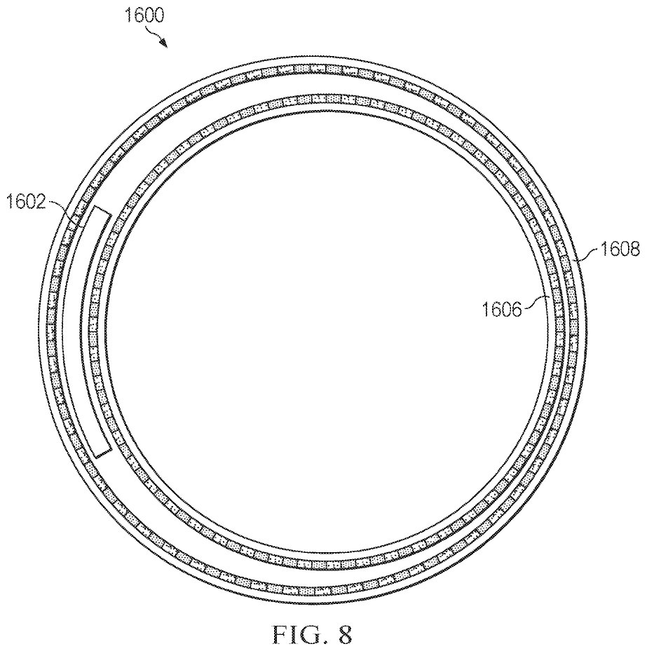

FIG. 8 is a schematic diagram of a cycloidal magnetic gear 1600 with a flux shield 1602 disposed between an inner rotor 1606 and an outer rotor 1608. Inner rotor 1606 may be, for example, rotor 40 from FIG. 7. As illustrated in FIG. 8, rotors 1606, 1608 are arranged eccentrically, and flux shield 1602 resides in the larger space created by the eccentricity. Inner rotor 1606 comprises a plurality of poles that is different in number than the plurality of poles of outer rotor 1608. Flux shield 1602 is made of a dual-phase magnetic material. In various embodiments, flux shield 1602 may be made of, for example, a dual phase magnetic material so as to create a monolithic structure with magnetic and nonmagnetic features. In such an arrangement, flux shield 1602 exhibits flux channels that direct magnetic flux from inner rotor 1606 in a desired direction before the magnetic flux interacts with outer rotor 1608. In this manner, flux shield 1602 converts what would otherwise be negative-acting torque into positive-acting torque. Because flux shield 1602 spins at the speed of the eccentric motion of the inner rotor 1606, which is driven by an input cam shaft, flux shield 1602, in various embodiments, can be coupled to the input cam shaft (not explicitly shown). Flux shield 1602 has a magnetic permanence and reluctance that creates a flux linking path between the inner and outer rotors so as to actually create a positive torque on the inner rotor. The effect of flux shield 1602 can be achieved through salient features, such as flux barriers, which may be made of electrical steel, steel laminae, or soft magnetic composite. Alternatively, flux shield 1602 may be made of dual phase magnetic material so as to create a monolithic structure with magnetic and nonmagnetic features, as shown in FIG. 8. In addition to countering the oppositional magnetic torque, flux shield 1602 may act as a counterweight, reduce bearing forces on the cycloid, and actually boost torque of the drive.

### Cycloidal Magnetic Gear Systems

Magnetic gears perform the same task as their mechanical counterparts. However, they do so through the modulated interaction between the flux generated by magnets instead of through mechanical interaction between teeth. A magnetically geared machine uses the flux produced by the coils of wire of a motor in combination with a magnetic gear to allow for a higher torque motor in a smaller package. The magnetic gear and motor often share structural material and often magnets that allow for a more compact and efficient design. To achieve high gear ratios using magnetic gears, having two or more magnetic gears nested or connected in series may be required. When multiple gears are connected, the net gear ratio of the multiple stage magnetic gear is the product of the gear ratios at each stage. The technologies discussed below relate to, but are not limited to, methods and apparatus for having multiple stages of magnetic gearboxes and magnetically geared machines in a small package, where many of the structural components are shared.

Technologies one through three are related to nested radial flux cycloidal magnetic gears. Various examples discussed below describe two-stage designs. Those having skill in the art will recognize that the designs can be scaled up to have more than two stages to achieve the required gear ratio.

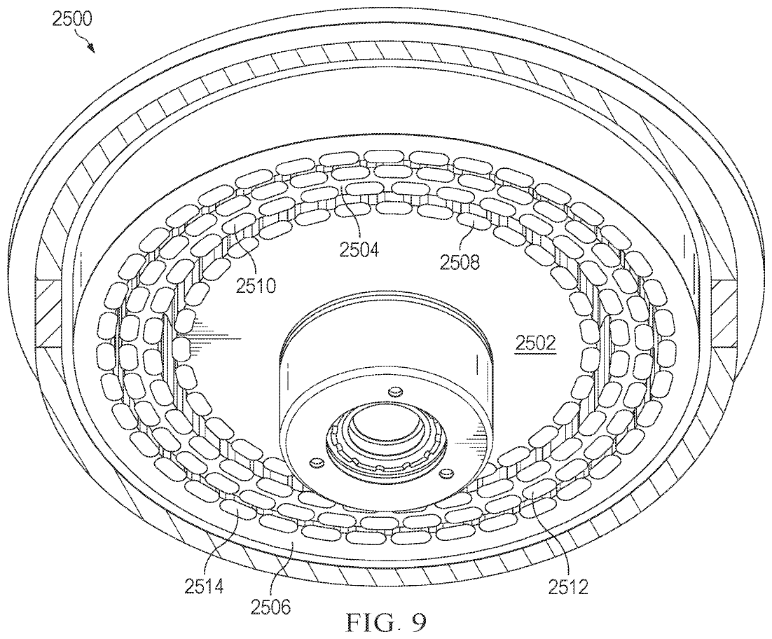

A first aspect involves a two-or more-stage radial flux cycloidal magnetic gear, wherein multiple cycloidal-type magnetic gearbox stages lie in the same plane to which all axes of rotation are perpendicular. FIG. 9 illustrates a two-stage embodiment of the disclosed aspect. Generally, this aspect includes a first radial flux cycloidal magnetic gear that lies in an inner bore of a second radial flux cycloidal magnetic gear. This can be repeated as many times as desired until the necessary gear ratio is achieved.

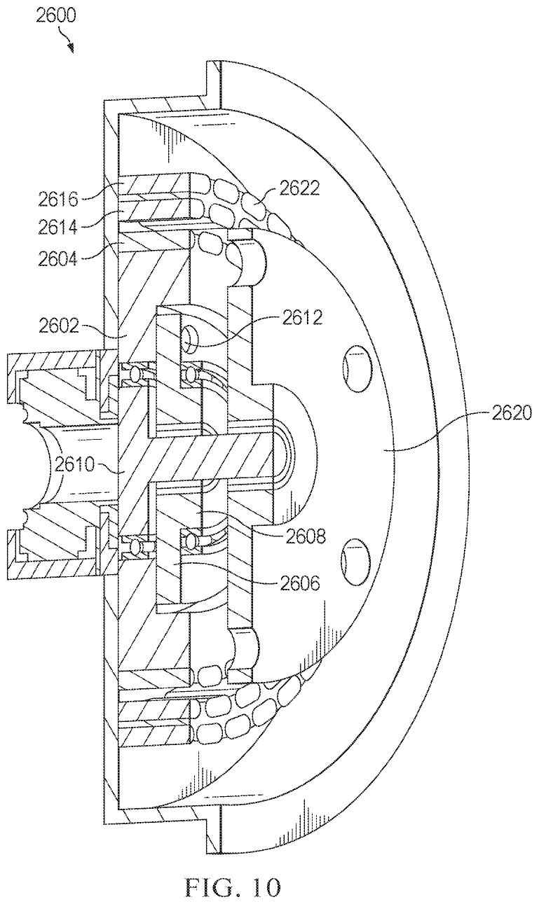

A second aspect is a method of practicing the nested, in-plane radial flux cycloidal magnetic gear topology. The second technology is the connection between consecutive stages of radial flux cycloidal magnetic gears using the component shown in FIG. 10. This aspect has a cam on one side of the disk that causes the eccentric motion of the following stage.

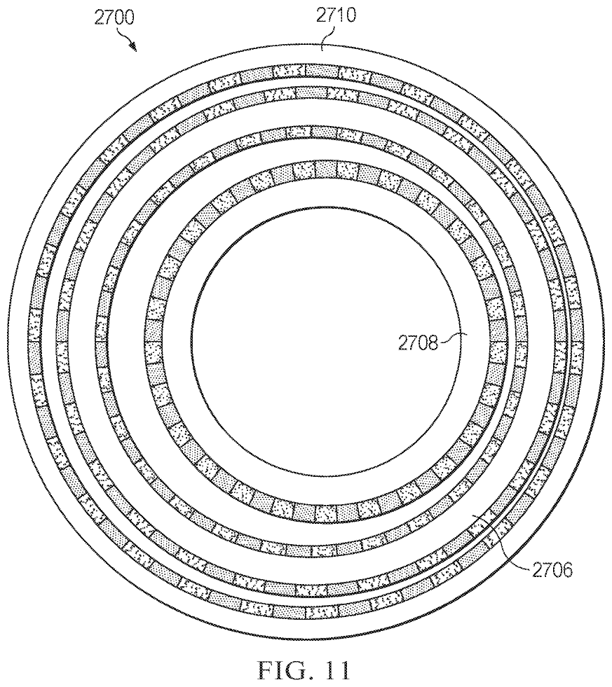

A third aspect is the concept of sharing the outer rotor of the first stage with the inner rotor of the cycloidal magnetic gear. In FIG. 11, an example of this aspect is shown with the nested radial flux cycloidal magnetic gear topology.

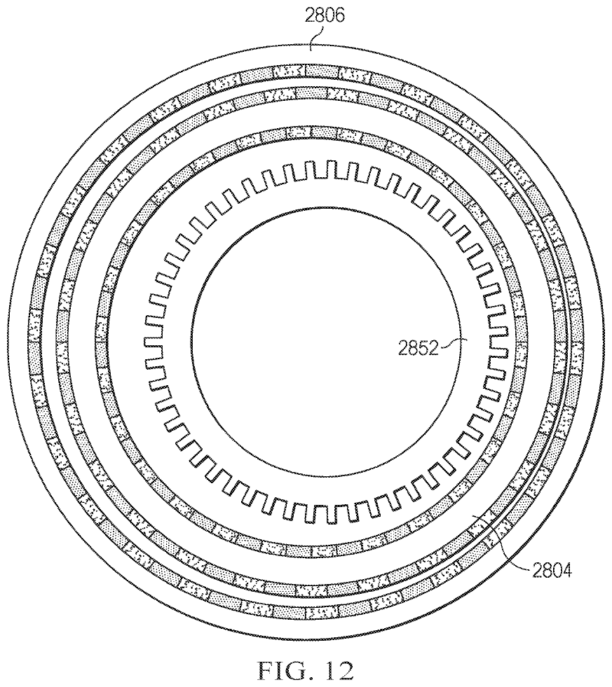

Embodiments of the first, second, and third aspects exist such that the inner or outer rotor of any of the stages may be of the surface permanent magnet topology having either conventional (North-South) magnetization, or Halbach array magnetization. Alternatively, the inner and/or outer rotors may be of the reluctance topology as in FIG. 12. Alternatively, the inner or outer rotors may be of the flux focusing or consequent pole topology. For the first, second, and third aspects (nested cycloidal) and the aspects described above, several embodiments exist wherein gearing is achieved by restricting specific degrees of motion.

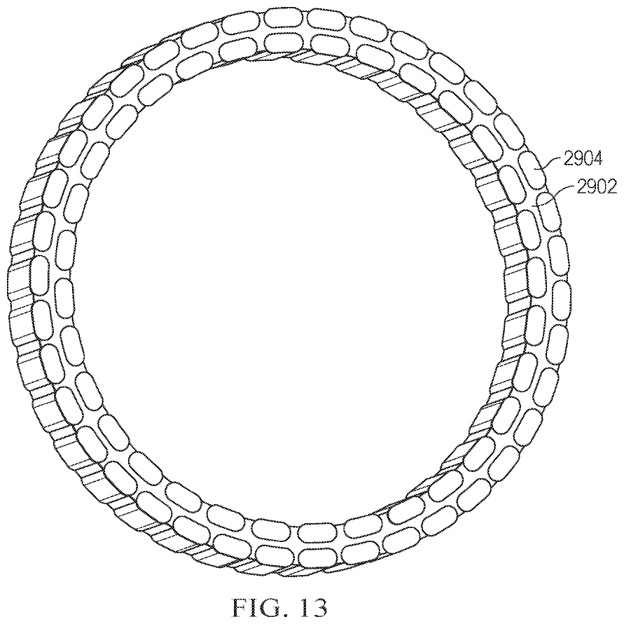

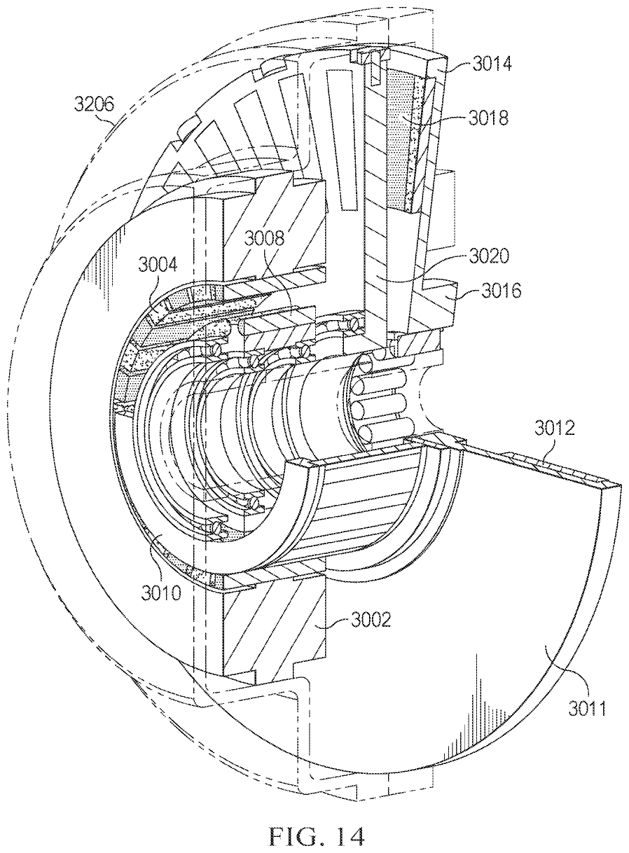

A fourth aspect relates to magnets having an oval shape that are press-fit into a structural back-iron for retention. The back iron may include, but is not limited to, an embodiment of the third aspect disclosed, wherein the structural back-iron retains a plurality of magnets used for the first and second stages, as shown in FIG. 13.

Aspects five through seven are related to nested radial flux coaxial magnetically geared machine connected to an axial flux coaxial magnetic gear.

A fifth aspect disclosed involves method and apparatus for systems involving electric machines and magnetic gears. The disclosed technology involves stator windings which are magnetically coupled to a radial flux coaxial magnetic gear. The low-speed rotor of the radial flux coaxial magnetic gear is mechanically connected to the high-speed rotor of an axial flux coaxial magnetic gear and is a single rigid body, as shown in FIG. 14.

Embodiments of the fifth aspect exist such that the modulators or outer rotor of the radial flux coaxial magnetic gear may be mechanically connected to the axial flux coaxial magnetic gear as a single rigid body.

A sixth aspect relates to grounded bodies of the radial flux coaxial magnetic gear-integrated electric machine, such as the housing holding the stator windings, may be shared with the grounded components of the axial flux coaxial magnetic gear.

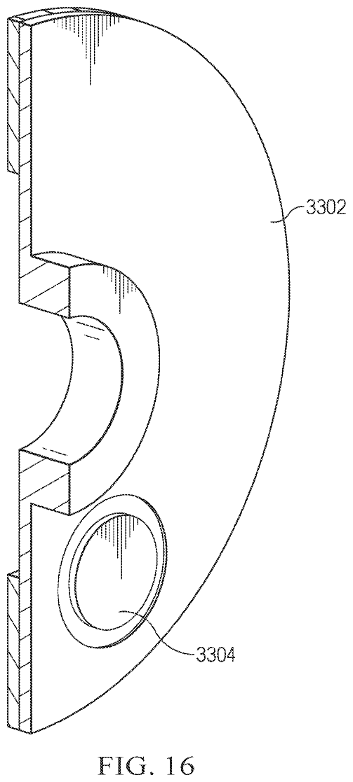

A seventh aspect disclosed involves a method and apparatus for axial flux coaxial magnetic gears. The disclosed technology involves placing bearings or rollers in-between the low pole-count high-speed rotor and the high pole-count posterior rotor, as shown in FIG. 16. The bearings keep the air gap between the rotors containing the magnets and the modulators consistent.

The fifth, sixth, and seventh aspects include configurations where the anterior low pole-count rotor of the axial flux coaxial magnetic gear is configured as a high-speed rotor and the posterior high pole-count rotor of the axial flux coaxial magnetic gear is configured to be fixed, leaving the modulators as the low-speed rotor that are configured to freely rotate. Alternatively, the modulators may be fixed, and the high pole-count posterior rotor may be configured to be a low-speed rotor. For all magnetic gears, involving the fifth, sixth, and seventh aspects, each rotor may contain surface permanent magnets of conventional or Halbach topology, or be of the consequent pole, flux focusing, or reluctance topologies.

Aspects eight, nine and ten are related to a radial flux cycloidal magnetic gear connected to an axial flux coaxial magnetic gear.

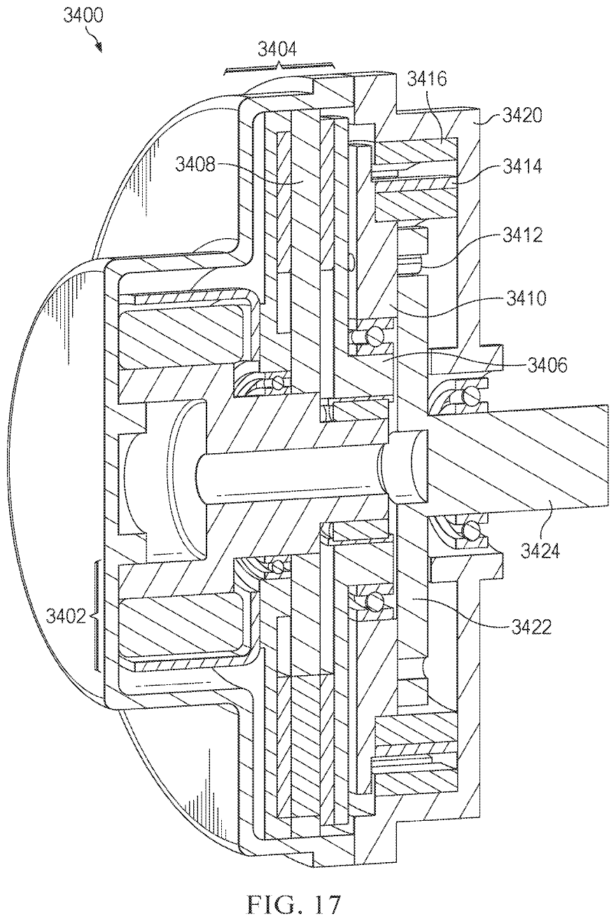

Aspect eight relates to a first stage axial flux coaxial magnetic gear that is integrated in series with a second stage radial flux cycloidal type magnetic gear. The low-speed rotor of the axial flux coaxial magnetic gear is mechanically coupled to the highspeed rotation of a radial flux cycloidal magnetic gear via the method shown in FIG. 17. The low-speed rotor of the axial flux coaxial magnetic gear has a cam on the side of the rotor without magnets that causes the eccentric motion of the following stage.

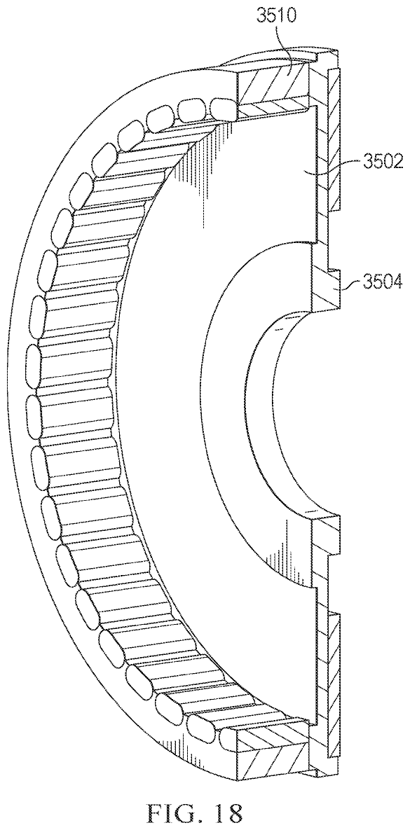

A ninth aspect is a modification of the eighth aspect, wherein there exists a first stage axial flux coaxial magnetic gear that is integrated in series with a second stage radial flux cycloidal type magnetic gear. The low-speed rotor of the axial flux coaxial magnetic gear is mechanically connected to the high-speed rotation of a radial flux cycloidal magnetic gear and is a single rigid body, as shown in FIG. 18. The high-speed motion of the radial flux cycloidal magnetic gear is eccentrically connected to the low-speed rotor of the axial flux coaxial magnetic gear which causes the eccentric motion of the following stage.

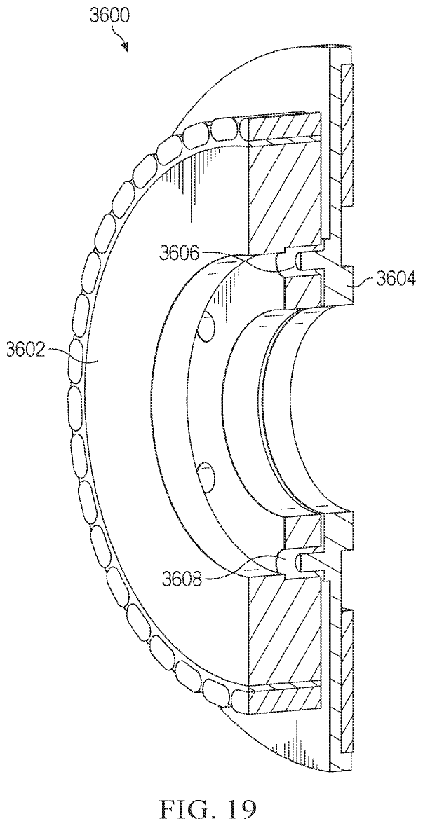

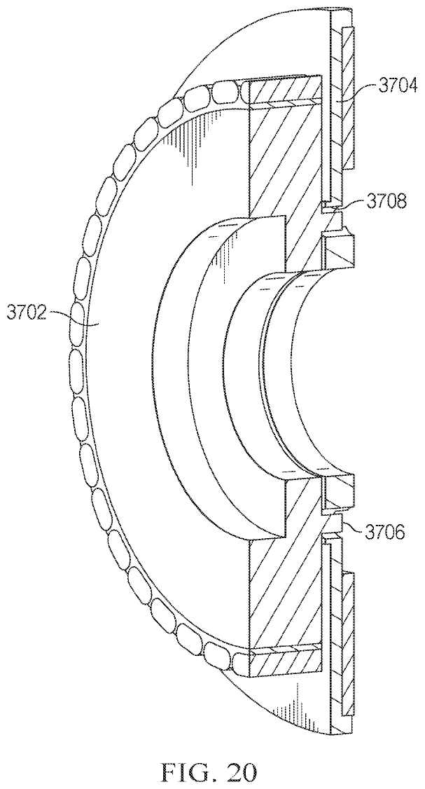

A tenth aspect is another modification of the eighth aspect, wherein the radial flux cycloidal magnetic gear is configured as a higher-speed first stage, and the axial flux coaxial magnetic gear is configured as the lower-speed second stage. The low-speed rotation of the radial flux cycloidal magnetic gear is mechanically connected to the high-speed rotor of an axial flux coaxial magnetic gear and is either mechanically coupled or a single rigid body, as shown in FIGS. 19, 20 and 21. When the low-speed rotation of the radial flux cycloidal magnetic gear is the outer rotor without eccentric motion, the outer rotor of the radial flux cycloidal magnetic gear is mechanically connected to the high-speed rotor of the axial flux coaxial magnetic gear, as shown in FIG. 19. When the low-speed rotation of the radial flux cycloidal magnetic gear is the rotation of the inner or outer rotor about its own axis while moving eccentrically, the high-speed rotor of the axial flux coaxial magnetic gear has pins extending toward the first stage that couple to holes of larger diameter on the output disk of the radial flux cycloidal magnetic gear as shown in FIGS. 20 and 21.

Embodiments of the eighth, ninth, and tenth aspects exist where the anterior low pole-count rotor of the axial flux coaxial magnetic gear is configured as a high-speed rotor, and the posterior high pole-count rotor of the axial flux coaxial magnetic gear is configured to be fixed, leaving the modulators as the low-speed rotor that is free to rotate. Alternatively, the modulators may be fixed, and the high pole-count posterior rotor may act as the low-speed rotor. For all magnetic gears, involving the eighth, ninth, and tenth technologies, each rotor may contain surface permanent magnets of conventional or Halbach topology, or be of the consequent pole, flux focusing, or reluctance topologies.

The aspects of FIGS. 9-21 above are discussed in more detail below. FIG. 9 is a perspective view of a multi-stage cycloidal magnetic gear 2500. The multi-stage cycloidal magnetic gear 2500 includes an inner rotor 2502, an intermediate rotor 2504, and an outer rotor 2506. The inner rotor 2502, the intermediate rotor 2504, and the outer rotor 2506 lie in the same plane to which all axes of rotation are perpendicular. A first plurality of magnetic pole pairs 2508 is disposed around a circumference of the inner rotor 2502. A second plurality of magnetic pole pairs 2510 is disposed about an inner circumference of the intermediate rotor 2504 and a third plurality of magnetic pole pairs 2512 is disposed about an outer circumference of the intermediate rotor 2504. A fourth plurality of magnetic pole pairs 2514 is disposed about an inner circumference of the outer rotor 2506. A two-stage cycloidal magnetic gear 2500 is shown in FIG. 9; however, in other embodiments, cycloidal magnetic gears utilizing principals of the disclosure could have any number of stages. Generally, the concept is that the first radial flux cycloidal magnetic gear lies in the inner bore of the second radial flux cycloidal magnetic gear. This can be continued as many times as desired until the necessary gear ratio is achieved.

FIG. 10 is a cross-sectional view of a multi-stage cycloidal magnetic gear 2600. An inner rotor 2602 has a first plurality of magnetic pole pairs 2604 coupled thereto. The inner rotor 2602 is coupled to a first pin disc 2606. The first pin disc 2606 includes a cam 2608 so as to induce eccentric motion about an input shaft 2610. During operation, rotation of the input shaft 2610 causes eccentric rotation of the inner rotor 2602. Pins 2612 extend from the inner rotor 2602 and drive the first pin disc 2606. The first plurality of magnetic pole pairs 2604 interact with a second plurality of magnetic pole pairs 2614, which are disposed on an intermediate rotor 2616 (hidden from view for the purposes of clarity). The intermediate rotor 2616 includes pins, which drive a second pin disc 2620 (similar to the manner in which pins 2612 drive pin disc 2606). The intermediate rotor 2616 includes a third plurality of magnetic pole pairs 2622 that are disposed on an external circumference of the intermediate rotor 2616. The third plurality of magnetic pole pairs 2622 interact with a fourth plurality of magnetic pole pairs (not shown) disposed on an outer rotor. The second pin disc 2620 drives an output shaft (not shown).

FIG. 11 is a cross-sectional view of a multi-stage cycloidal magnetic gear 2700. An intermediate rotor 2706 is utilized, which interacts with both an inner rotor 2708 and an outer rotor 2710. Embodiments shown in FIGS. 9-11 exist such that the inner or outer rotor of any of the stages may be of the surface permanent magnet topology having either conventional (North-South) magnetization, or Halbach array magnetization, or any other magnetization. In various embodiments, the inner and/or outer rotors may be of the reluctance topology as shown in FIG. 12. Although FIG. 12 depicts the inner rotor 2852 being of consequent pole topology, in various embodiments, inner rotor 2802, intermediate rotor 2804, or outer rotor 2806 may be of the flux focusing or consequent pole topology.

FIG. 13 is a perspective view of a back iron 2902 having magnets 2904 disposed thereon. In various embodiments, magnets 2904 have an oval-shaped cross-section that is configured to be press-fit into a contoured feature (e.g., each contoured feature has a shape that complements the shape of the magnets) of the back-iron 2902 for retention. The back iron 2902 may include, but is not limited to, the embodiments illustrated in FIGS. 9-13 above, in which the structural back-iron 2902 retains the plurality of magnets 2904. For example, in the embodiment shown in FIG. 13, the back iron is illustrated as being used in the intermediate rotor 2616; however, in other embodiments, the back iron 2902 could be utilized as the inner rotor 2602 or the outer rotor. Back iron 2902 may be configured to retain magnets on an inner surface and an outer surface as illustrated in FIG. 13.

FIG. 14 is a cross-sectional view of the magnetic gear system 3000 viewed from an input side and having an outer housing 3206. A flange 3011 extends radially from the flux modulator 3010. A third plurality of magnetic pole pairs 3012 are arranged on the flange 3011 such that the magnetic flux of the third plurality of magnetic pole pairs 3012 propagates axially relative to the input shaft 3006. An output rotor 3014 is coupled to an output shaft 3016. A fourth plurality of magnetic pole pairs 3018 are arranged on the output rotor 3014 such that the magnetic flux of the fourth plurality of magnetic pole pairs 3018 propagates axially relative to the input shaft 3006. A second flux modulator 3020 is disposed between the third plurality of magnetic pole pairs 3012 and the fourth plurality of magnetic pole pairs 3018. During operation, the second modulator 3020 remains stationary. Rotation of the flange 3011 causes magnetic interaction between the third plurality of magnetic pole pairs 3012, the second flux modulator 3020, and the fourth plurality of magnetic pole pairs 3018 such that the output rotor 3014 rotates at a predetermined ratio relative to the flange 3011. In various embodiments, the flux modulator 3010 and the second flux modulator 3020 or output rotor 3014 may be mechanically connected as a single rigid body.

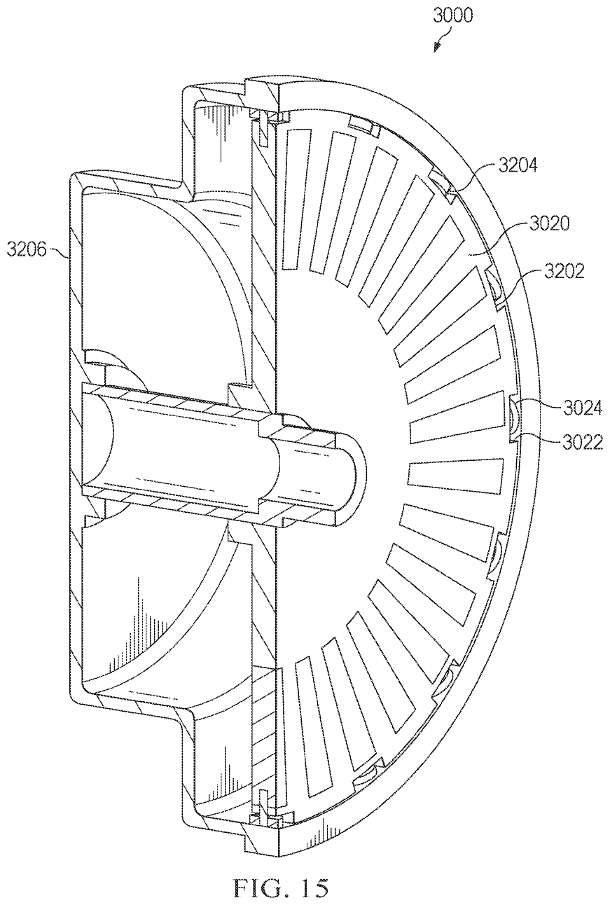

FIG. 15 is a cross-sectional view of the magnetic gear system 3000 showing the second flux modulator 3020. In various embodiments, notches 3202 are formed in the circumference of the second flux modulator rotor 3020. Bearings 3204 are disposed in the notches and engage the outer housing 3206. In various embodiments, the bearings 3204 maintain a constant air gap between the flange 3011, the second flux modulator 3020, and the output rotor 3018. By way of example, the bearings 3204 are illustrated in FIG. 16 as being roller bearings; however, in other embodiments, any type of bearing can be utilized. During operation, the bearings 3204 also secure the second flux modulator 3020 to the outer housing 3206 and prevent rotation of the second flux modulator 3020.

In various embodiments of the arrangements illustrated in FIGS. 14-15, the flange 3011 of is the high-speed rotor and the output rotor 3014 of the axial flux coaxial magnetic gear is fixed, leaving the second flux modulator 3020 as the low-speed rotor that is free to rotate. Alternatively, the second flux modulator 3020 may be fixed, and the output rotor 3014 acts as the low-speed rotor. In the embodiments illustrated in FIGS. 14-15, each rotor may contain surface permanent magnets of conventional or Halbach topology, or be of the consequent pole, flux focusing, or reluctance topologies.

FIG. 16 is an output side view of an output rotor 3302 of an axial flux magnetic gear. In various embodiments, the output rotor 3302 axial flux magnetic gear may be coupled to an input rotor of a radial flux cycloidal magnetic gear (not explicitly shown). A cam 3304 is formed on a face of the output rotor 3302. The cam is coupled to the input rotor of the radial flux cycloidal magnetic gear and drives eccentric rotation of the input rotor of the radial flux cycloidal magnetic gear.

FIG. 17 is a cross-sectional view of a three-stage magnetic gear system 3400. The three-stage magnetic gear system 3400 includes a first stage 3402 and a second stage 3404. In various embodiments, the first stage 3402 is a radial-flux magnetic gear and the second stage 3404 is an axial-flux magnetic gear. In various embodiments, the first stage 3402 and the second stage 3404 are constructed and function similar to those described above with respect to FIGS. 14-16 15. A cam 3406 is disposed on an axial output rotor 3408. During operation, the cam 3406 imparts eccentric rotational motion to a cycloidal rotor 3410. A first plurality of magnetic pole pairs 3414 is disposed on an outer circumference of the cycloidal rotor 3410. A second plurality of magnetic pole pairs 3416 is disposed on an inner circumference of the housing 3420. During operation, magnetic interaction between the first plurality of magnetic pole pairs 3414 and the second plurality of magnetic pole pairs 3416 induces rotation of the cycloidal rotor 3410 at a pre-determined ratio relative to the eccentric rotation produced by the cam 3406. A plurality of pins 3412 extend from the cycloidal rotor 3410. The pins 3412 drive an output plate 3422. The output plate is coupled to an output shaft 3424. In various embodiments, a low-speed rotor of the axial flux coaxial magnetic gear second stage 3404 is mechanically connected to a high-speed rotation of a radial flux cycloidal rotor 3410 and is a single, rigid body. In such embodiments, the high-speed motion of the radial flux cycloidal magnetic rotor 3410 is eccentrically connected to the low-speed rotor of the axial flux coaxial magnetic gear second stage 3404 which causes the eccentric motion of the cycloidal rotor 3510.

FIG. 18 is a cross-sectional view of a magnetic gear system 3600 where a radial flux cycloidal magnetic gear 3502 is a higher speed first stage and an axial flux coaxial magnetic gear 3504 is the lower speed second stage. The low-speed rotation of the radial flux cycloidal magnetic gear 3502 is mechanically connected to the high-speed rotor of an axial flux coaxial magnetic gear 3504 and is either mechanically coupled or is a single rigid body. In various embodiments, when the low-speed rotation of the radial flux cycloidal magnetic gear 3502 is the outer rotor 3510 without eccentric motion (not explicitly shown), the outer rotor of the radial flux cycloidal magnetic gear 3502 is mechanically connected to the high-speed rotor of the axial flux coaxial magnetic gear, as shown in FIG. 18. FIG. 19 is a cross-sectional view of a magnetic gear system 3600. In various embodiments, when the low-speed rotation of the radial flux cycloidal magnetic gear 3602 is the rotation of the inner or outer rotor about its own axis while moving eccentrically, the high-speed rotor of the axial flux coaxial magnetic gear 3604 has pins 3606 extending toward the first stage 3602 that couple to holes 3608 of larger diameter on the output disk of the radial flux cycloidal magnetic gear 3602, as shown in FIG. 20.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

1-2. (canceled)

3. A modular system for forming a low-pole count rotor and a high-pole count rotor, the system comprising:
a plurality of magnet segments, each magnet segment having the same dimensions,
wherein the low-pole count rotor comprises poles made up of multiple magnet segments placed adjacent to one another; and
wherein the high-pole count rotor comprises poles made up of fewer magnet segments than the poles of the low-pole count rotor.

4. The modular system of claim 3, wherein each pole of the low-pole rotor comprises two or more magnet segments.

5. The modular system of claim 3, wherein each magnet segment is an arc-shaped magnet segment.

6. The modular system of claim 3, wherein each magnet segment is a rectangular magnet.

7-9. (canceled)

10. A multi-stage cycloidal magnetic gear system comprising at least two cycloidal magnetic gears nested in-plane.

11. The multi-stage cycloidal magnetic gear system of claim 10, further comprising: a first pin disk coupled to an inner rotor of a first stage of the multi-stage cycloidal magnetic gear system and comprising a cam, wherein the cam is configured to create eccentric motion of a second stage of the multi-stage cycloidal magnetic gear system.

12. The multi-stage cycloidal magnetic gear system of claim 11, wherein the first stage of the multi-stage cycloidal magnetic gear system includes an outer rotor that is shared with an inner rotor of a second stage of the multi-stage cycloidal magnetic gear system.

13-18. (canceled)

19. A multi-stage magnetic gear system comprising:
a radial flux cycloidal magnetic gear that is configured to be a higher-speed first stage; and
an axial flux coaxial magnetic gear that is configured to be a lower-speed second stage,
wherein the radial flux cycloidal magnetic gear is connected to a high-speed rotor of the axial flux coaxial magnetic gear as a single rigid body, and
wherein the radial flux cycloidal magnetic gear is configured as an outer rotor without eccentric motion and the outer rotor of the radial flux cycloidal magnetic gear is mechanically connected to the high-speed rotor of the axial flux coaxial magnetic gear.

20. (canceled)
